(19) United States
(12) Patent Application Publication
(10) Pub. No.: US 2006/0111887 A1
(43) Pub. Date: May 25, 2006

(54) Three-dimensional CAD apparatus, method for supporting design work for three-dimensional shapes, and computer product

(75) Inventors: Kazuhiro Takeuchi, Shizuoka (JP); Masahiro Nagakura, Shizuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/089,151

(22) Filed: Mar. 25, 2005

(30) Foreign Application Priority Data
Nov. 19, 2004 (JP) 2004-336570

(51) Int. Cl. G06F 9/45

(52) U.S. Cl. 703/22

(57) ABSTRACT

A computer-readable recoding medium that stores a computer program for supporting designing work for three-dimensional shapes causes a computer to execute recognizing a shape of a space based on information inputted to the three-dimensional CAD apparatus; generating space element data that represents the shape of the space; generating a attribute data based on the information; associating the attribute data with the space element data; and performing processing defined by the attribute data according to the space element data.

### BACKGROUND OF THE INVENTION

1) Field of the Invention

The present invention relates to a three-dimensional CAD (Computer Aided Design) program and a three-dimensional CAD apparatus that support designing work for three-dimensional shapes. In particular, the present invention relates to a three-dimensional CAD program and a three-dimensional CAD program that can treat spaces of various shapes as shape information and support a designer's work using the shape information of the spaces.

2) Description of the Related Art

Three-dimensional CAD apparatuses are widely used to design three-dimensional shapes of objects. When a designer designs an object, by using a three-dimensional CAD apparatus, the designer can create a three-dimensional model of the object in a three-dimensional space in an information processing apparatus, and perform volume calculation, interference check, and the like using the created three-dimensional model. Thus, the three-dimensional CAD apparatuses are used to support a designer's work.

When designing work is performed actually, it is sometimes required to design a space, where no object is present, with an intention. Thereby, the three-dimensional CAD apparatuses are also required to support designing of space portions. To meet such a demand, Japanese Patent Application Laid-Open No. 2002-312408 and Japanese Patent Application Laid-Open No. H11-143929 disclose techniques for three-dimensional CAD apparatuses. These three-dimensional CAD apparatuses can treat a shape of a hole, which is a blank portion and is necessary for attaching a component, as shape information, and perform designing and analysis work for such a shape efficiently.

However, the above conventional techniques have a problem. The space portions required to be designed with an intention are not limited to a hole portion in deed. In FIG. 1, an example of such space portions is shown, and a combustion chamber in a combustion engine is indicated as a blank portion. The combustion chamber is a space surrounded by a cylinder, a head, and a piston. In designing of the combustion chamber, it is extremely important to set a volume (a stroke volume) to a predetermined amount. The problem is that, in the above conventional techniques, it is impossible to treat spaces having complicated shapes, such as the combustion chamber, as shape information, and to calculate a volume of the combustion chamber using a three-dimensional model.

### SUMMARY OF THE INVENTION

It is an object of the present invention to at least solve the problems in the conventional technology.

According to one aspect of the present invention, a computer-readable recoding medium that stores a computer program for supporting designing work for three-dimensional shapes causes a computer to execute recognizing a shape of a space based on information inputted to the three-dimensional CAD apparatus;

generating space element data that represents the shape of the space;

generating a attribute data based on the information; associating the attribute data with the space element data; and performing processing defined by the attribute data according to the space element data.

According to another aspect of the present invention, a three-dimensional CAD apparatus that supports designing work for three-dimensional shapes includes a space-element processing unit that recognizes a shape of a space based on information inputted to the three-dimensional CAD apparatus, and generates space element data that represents the shape of the space; an attribute processing unit that generates an attribute data based on the information; and an association processing unit that associates the attribute data with the space element data, and performs processing defined by the attribute data according to the space element data.

According to still another aspect of the present invention, a method for supporting designing work for three-dimensional shapes includes recognizing a shape of a space based on information inputted to the three-dimensional CAD apparatus; generating space element data that represents the shape of the space; generating a attribute data based on the information; associating the attribute data with the space element data; and performing processing defined by the attribute data according to the space element data.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is an example of a space that is designed with a design intention;

FIG. 2 is a functional block diagram of a three-dimensional CAD apparatus according to an embodiment of the present invention;

FIG. 3 is an example of a space element of an inclusive-point definition type;

FIG. 4 is an example of a space element of a series-of-surfaces definition type;

FIG. 5 is an example of a space element of a route definition type;

FIG. 6 is an example of a space element of a fixed-shape definition type;

FIG. 7 is an example of a space element of a locus definition type;

FIG. 8 is an example of a storage system for a space element of the inclusive-point definition type;

FIG. 9 is an example of a storage system for a space element of the series-of-surfaces definition type;

FIG. 10 is an example of a storage system for a space element of the route definition type;

FIG. 11 is an example of a storage system for a space element of the fixed-shape definition type;

FIG. 12 is an example of a storage system for a space element of the locus definition type;

FIG. 13 is a flowchart of a processing procedure of the three-dimensional CAD apparatus shown in FIG. 2;

FIG. 14 is a schematic for explaining an operation to be performed when a shape of a space element, to which an attribute of displaying a volume as a comment is added, is changed;

FIG. 15 is a schematic for explaining an operation to be performed when an attribute of displaying a warning is set in a space element;

FIG. 16 is a schematic for explaining an operation to be performed when an attribute of prohibiting operation by a user is set in a space element;

FIG. 17 is a flowchart of a processing procedure to be taken when a shape of a space element is changed;

FIG. 18 is a functional block diagram of a computer that executes a three-dimensional CAD program;

FIG. 19A is an example of a conventional description system for space information;

FIG. 19B is another example of the conventional description system for space information; and

FIG. 20 is a schematic for explaining an operation to be performed when a shape of a space is changed in the conventional description system for space information.

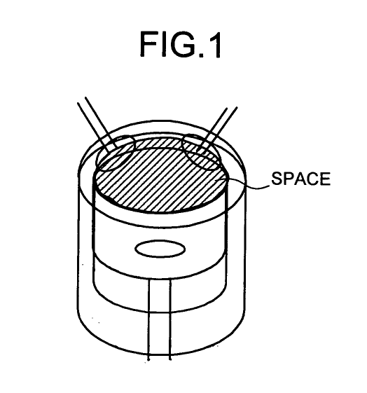

### DETAILED DESCRIPTION

Exemplary embodiments of the present invention are explained in detail below with reference to the accompanying drawings.

Before explaining an embodiment of the present invention, it is explained how a space is treated in a conventional design method. In a conventional general three-dimensional CAD apparatus, a space is not treated as shape information and is not outputted to design data that is generated by the three-dimensional CAD apparatus. Therefore, a method described below is adopted when a designer describes information concerning a space (hereinafter, “space information”).

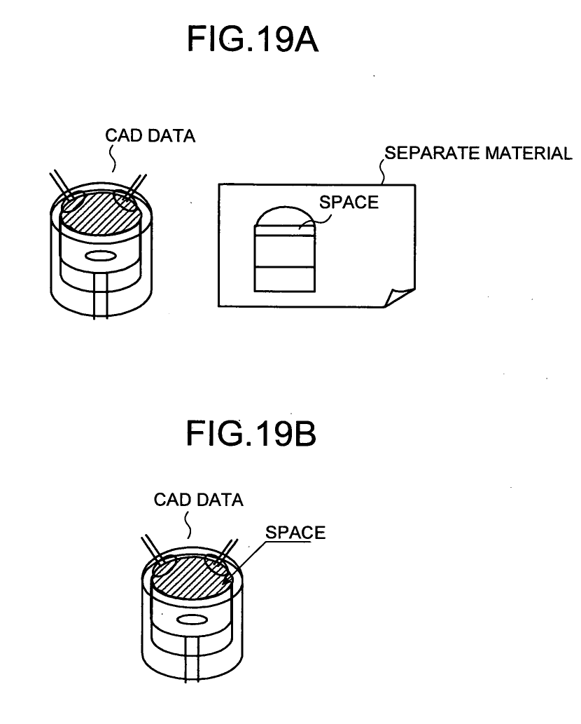

FIGS. 19A and 19B are schematics of examples of a conventional description system for space information. In the system shown in FIG. 19A, a material is prepared separately from design data and space information is described in the material. In the system shown in FIG. 19B, a comment is added to one of surfaces forming a space and space information is described on the surface.

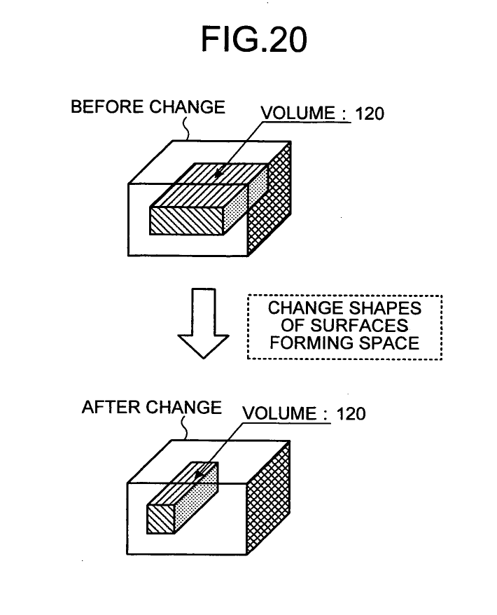

In these systems, since the design data and the space information are separated, it is impossible to use the design data and the space information in association with each other. In addition, inconsistency may occur between the design data and the space information. FIG. 20 is a schematic for explaining an operation to be performed when a shape of a space is changed in the conventional description systems. As shown in the figure, a comment is added to one of surfaces forming the space to indicate that a volume of the space is 120 milliliters.

Even if shapes of surfaces forming the space are changed and the volume of the space is changed, the comment still indicates that the volume is 120 milliliters. A designer needs to correct the comment to change the indicated volume to a correct value. If the designer neglects the correction of the comment, inconsistency occurs between an actual volume of the space and the volume indicated by the comment.

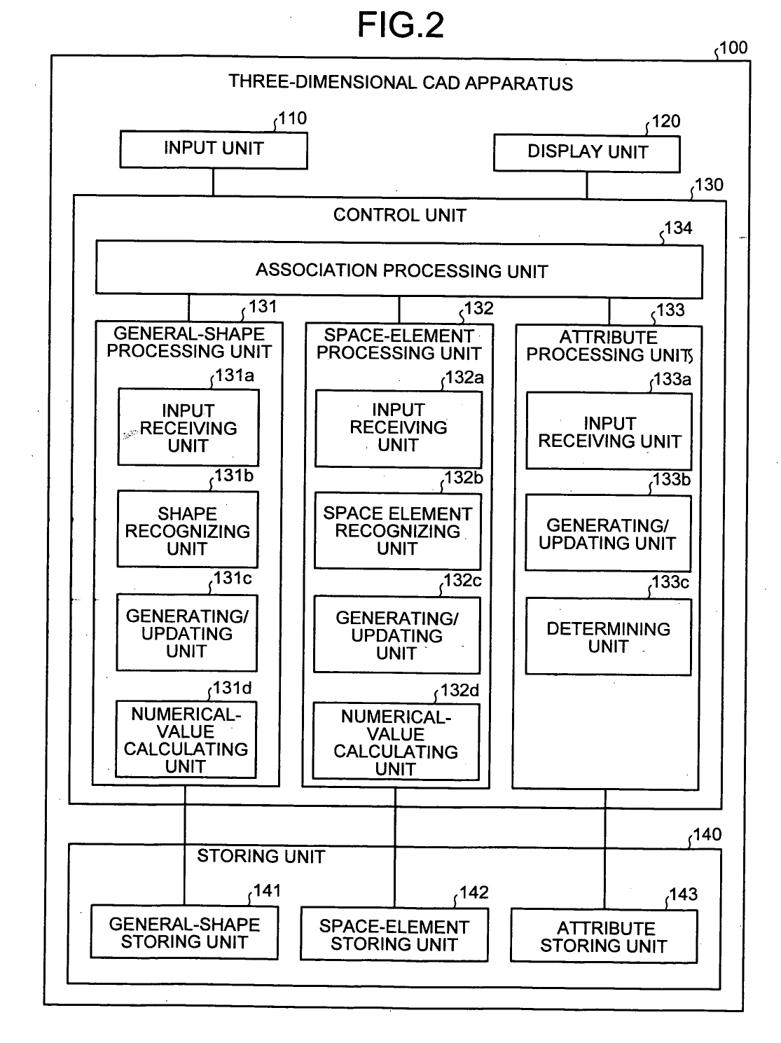

Next, a structure of a three-dimensional CAD apparatus 100 according to the embodiment is explained. FIG. 2 is a functional block diagram of the three-dimensional CAD apparatus 100 according to the embodiment. The three-dimensional CAD apparatus 100 includes an input unit 110, a display unit 120, a control unit 130, and a storing unit 140. The input unit 110 consists of an input device like a keyboard or a mouse. The display unit 120 consists of a display device like a liquid crystal monitor.

The control unit 130 is a device that controls the entire three-dimensional CAD apparatus 100. The control unit 130 includes a general-shape processing unit 131, a space-element processing unit 132, an attribute processing unit 133, and an association processing unit 134. The general-shape processing unit 131 is a processing unit that processing shapes like a point, a line, a surface, and a model (solid) that have been objects to be processed by the three-dimensional CAD apparatuses conventionally. The general-shape processing unit 131 includes an input receiving unit 131a, a shape recognizing unit 131b, a generating/updating unit 131c, and a numerical-value calculating unit 131d.

The input receiving section 131a is a processing unit that receives input information inputted by a user via the input unit 110. The shape recognizing unit 131b is a processing unit that recognizes the shapes such as a point, a line, a surface, and a model based on the information received by the input receiving unit 131a. The generating/updating unit 131c is a processing unit that generates or updates three-dimensional data based on the shapes recognized by the shape recognizing unit 131b. The numerical-value calculating unit 131d is a processing unit that calculates numerical values like a length, an area, and a volume relating to the shapes based on the three-dimensional data generated or updated by the generating/updating unit 131c.

The space-element processing unit 132 is a processing unit that performs processing for treating a space as a shape. The space-element processing unit 132 includes an input receiving unit 132a, a space-element recognizing unit 132b, a generating/updating unit 132c, and a numerical-value calculating unit 132d.

The input receiving unit 132a is a processing unit that receives the input information inputted by the user via the input unit 110. The space-element recognizing unit 132b is a processing unit that recognizes a shape of a space based on the information received by the input receiving unit 132a. The generating/updating unit 132c is a processing unit that generates or updates three-dimensional data representing the space based on the shape recognized by the space-element recognizing unit 132b. The numerical-value calculating unit 132d is a processing unit that calculates numerical values like a surface area and a volume of the space based on the thee-dimensional data generated or updated by the generating/updating unit 132c.

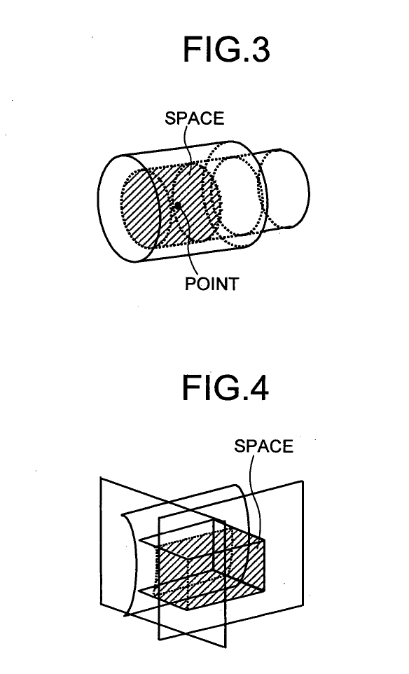

Types of spaces recognized by the space-element recognizing unit 132b are explained citing examples. FIG. 3 is a schematic of an example of a space element of an inclusive-point definition type. As shown in the figure, in the inclusive-point definition type, a point (coordinates) is designated and a closed spaced including the point is defined as a space element. FIG. 4 is a schematic of an example of a space element of a series-of-surfaces definition type. As shown in the figure, in the series-of-surfaces definition type, a series of surfaces are designated and a closed space surrounded by the series of surfaces is defined as a space element.

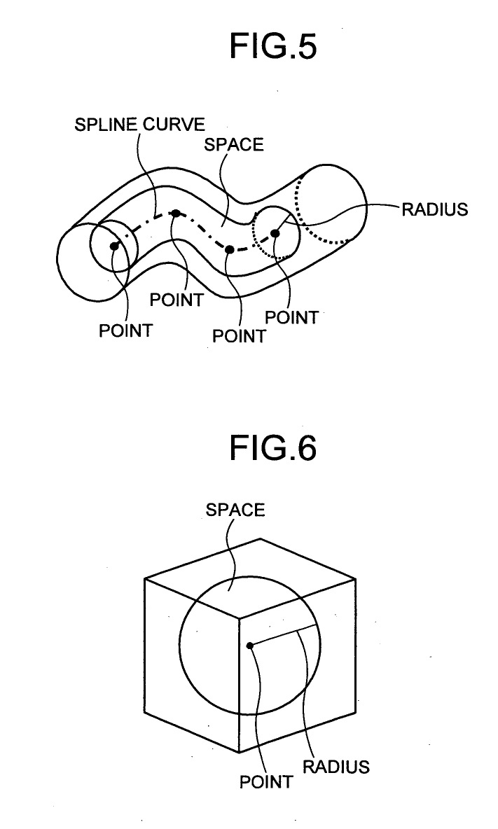

FIG. 5 is a schematic of an example of a space element of a route definition type. As shown in the figure, in the route definition type, a series of points are designated and a closed space, which is formed by a specific shape (a circle with a fixed radius, etc.) passing along a route passing the series of points (a spline curve connecting the series of points, etc.), is defined as a space element. FIG. 6 is a schematic of an example of a space element of a fixed-shape definition type. As shown in the figure, in the fixed-shape definition type, a point (coordinates) is designated and a fixed shape (a sphere, etc.) around the point is defined as a space element.

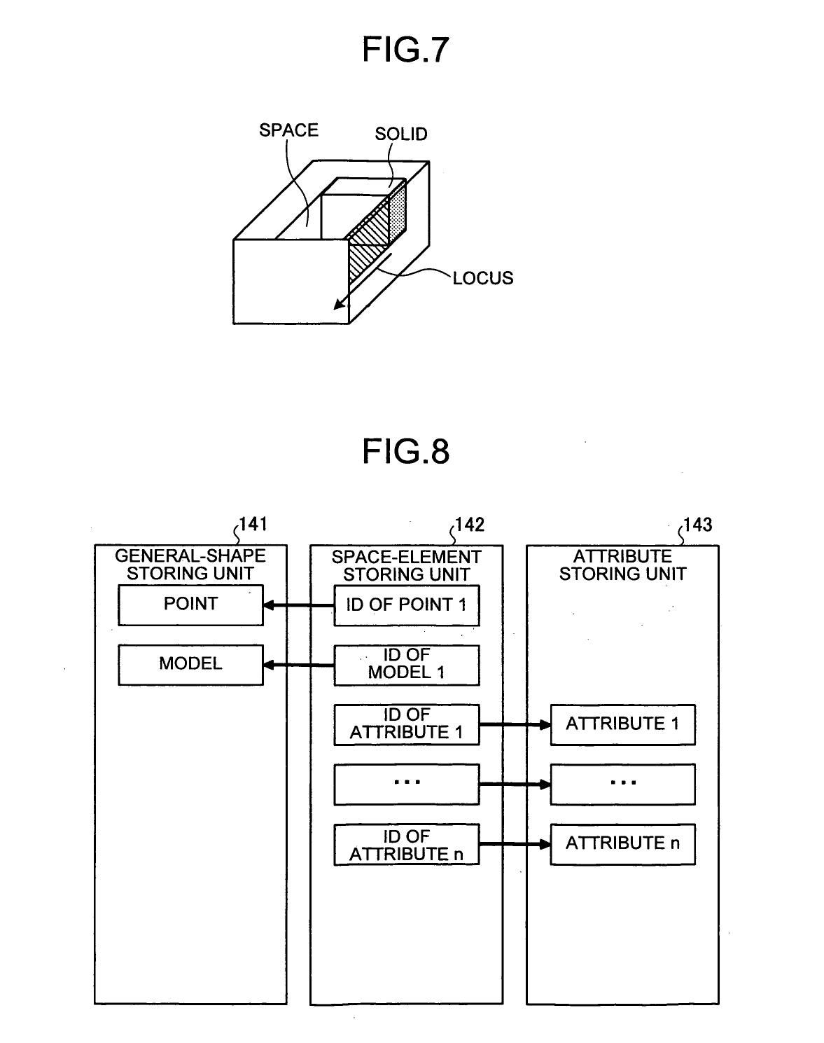

FIG. 7 is a schematic of an example of a space element of a locus definition type. As shown in the figure, in the locus definition type, a surface or a model is designated and a closed space, which is formed by a locus of the surface or the model moving along a line, is defined as a space element.

It is also possible to combine the plural types of spaces explained above to define one space. In this way, the three-dimensional CAD apparatus according to the embodiment can treat spaces of various shapes.

Referring back to FIG. 2, the attribute processing unit 133 is a processing unit that processes attribute information added to a general shape or a space element. The attribute processing unit 133 includes an input receiving unit 133a, a generating/updating unit 133b, and a determining unit 133c. There are plural kinds of attributes like a comment and an instruction for issuing a warning when a certain condition (threshold value) is met.

The input receiving unit 133a is a processing unit that receives the input information inputted by the user via the input unit 110. The generating/updating unit 133b is a processing unit that generates or updates attribute data based on the information received by the input receiving unit 133a. The determining unit 133c is a processing unit that, when attribute data includes some condition (threshold value), determines whether a state meets the condition (the threshold value is exceeded).

The association processing unit 134 is a processing unit that associates a general shape or a space element with an attribute, invokes the numerical-value calculating unit 131d, the numerical-value calculating unit 132d, or the determining unit 133c as required, and executes processing set in the attribute. For example, when an attribute of displaying a warning when a volume of a space exceeds a predetermined volume is added to a space element, the association processing unit 134 acquires a volume from the numerical-value calculating unit 132d every time a shape of the space is changed, passes the volume to the determining unit 133c, and causes the determining unit 133c to determine whether the volume exceeds the condition. When it is determined that the volume exceeds the condition, the association processing unit 134 displays a warning.

The storing unit 140 stores various kinds of information. The storing unit 140 includes a general-shape storing unit 141, a space-element storing unit 142, and an attribute storing unit 143. The general-shape storing unit 141, the space-element storing unit 142, and the attribute storing unit 143 are storing units that store data generated or updated by the generating/updating unit 131c, the generating/updating unit 132c, and the generating/updating unit 133b, respectively.

As described above, since a space element is defined using a general shape, the space element is stored in the space-element storing unit 142 in association with the general-shape storing unit 141. When an attribute is added to the space element, the space element is also associated with the attribute storing unit 143. A storage system for a space element is explained below citing examples.

FIG. 8 is a schematic of an example of a storage system for a space element of the inclusive-point definition type. As shown in the figure, a model and a point in the model are stored in the general-shape storing unit 141, and an ID of the model and an ID of the point are stored in the space-element storing unit 142 as a space element of the inclusive-point definition type. In addition, zero or more attributes are stored in the attribute storing unit 143, and IDs of the attributes are also stored in the space-element storing unit 142.

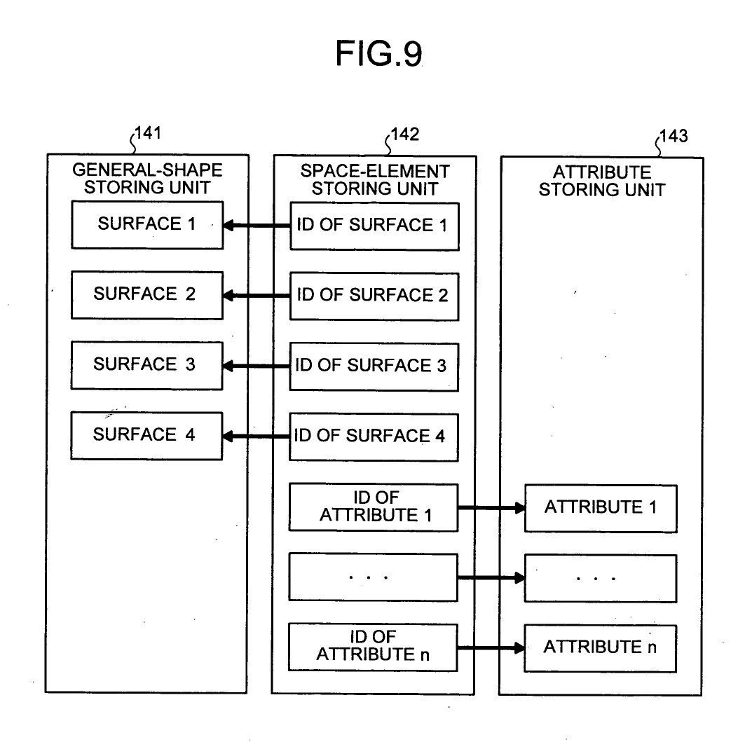

FIG. 9 is a schematic of an example of a storage system for a space element of the series-of-surfaces definition type. As shown in the figure, plural surfaces are stored in the general-shape storing unit 141, and IDs of the surfaces are stored in the space-element storing unit 142 as a space element of the series-of-surfaces definition type. In addition, zero or more attributes are stored in the attribute storing unit 143, and IDs of the attributes are also stored in the space-element storing unit 142.

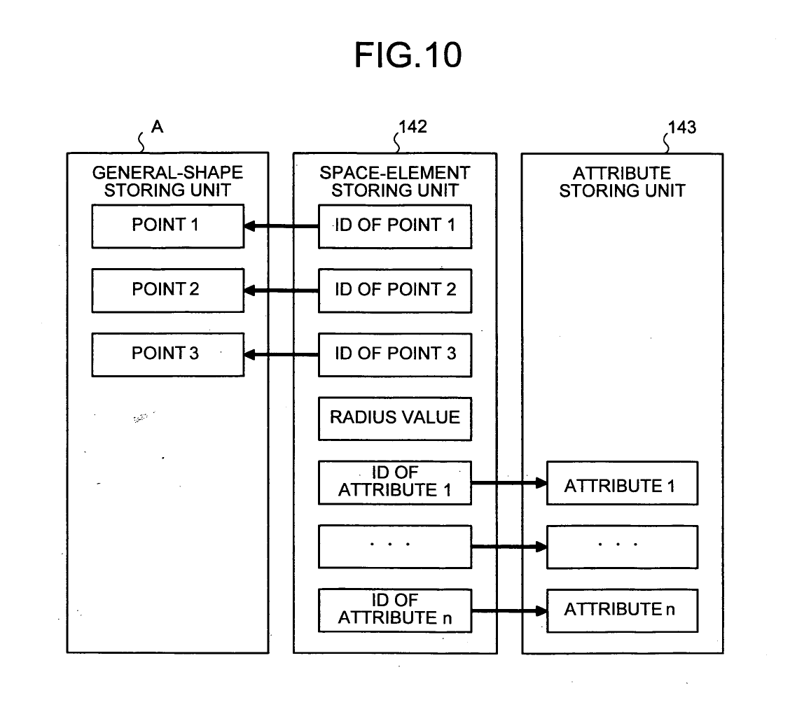

FIG. 10 is a schematic of an example of a storage system for a space element of the route definition type. In this example, a space formed by a circle with a fixed radius passing along a route connecting a series of points is set as a space element. As shown in the figure, plural points are stored in the general-shape storing unit 141, and IDs of the points and a radius value of the circle are stored in the space-element storing unit 142 as a space element of the route definition type. In addition, zero or more attributes are stored in the attribute storing unit 143, and IDs of the attributes are also stored in the space-element storing unit 142.

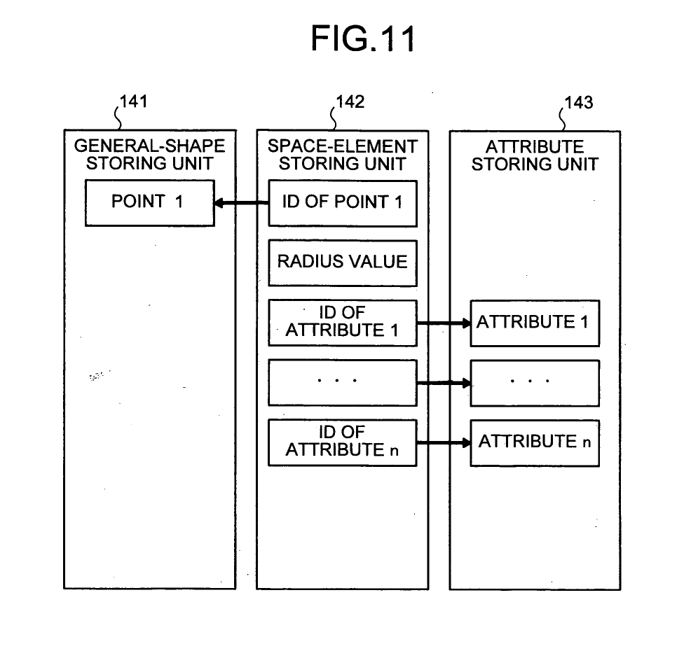

FIG. 11 is a schematic of an example of a storage system for a space element of the fixed-shape definition type. In this example, a sphere around a point is set as a space element. As shown in the figure, a point is stored in the general-shape storing unit 141, and an ID of the point and a radius value of the sphere are stored in the space-element storing unit 142 as a space element of the fixed-shape definition type. In addition, zero or more attributes are stored in the attribute storing unit 143 and IDs of the attributes are also stored in the space-element storing unit 142.

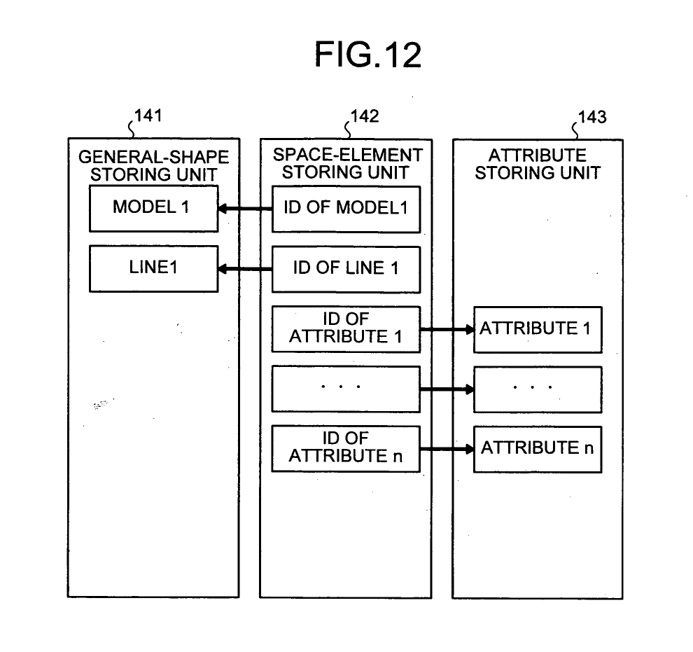

FIG. 12 is a schematic of an example of a storage system for a space element of the locus definition type. In this example, a closed space created by a locus of a model moving along a line is set as a space element. As shown in the figure, a model and a line are stored in the general-shape storing unit 141, and an ID of the model and an ID of the line are stored in the space-element storing unit 142 as a space element of the locus shape definition type. In addition, zero or more attributes are stored in the attribute storing unit 143, and IDs of the attributes are also stored in the space-element storing unit 142.

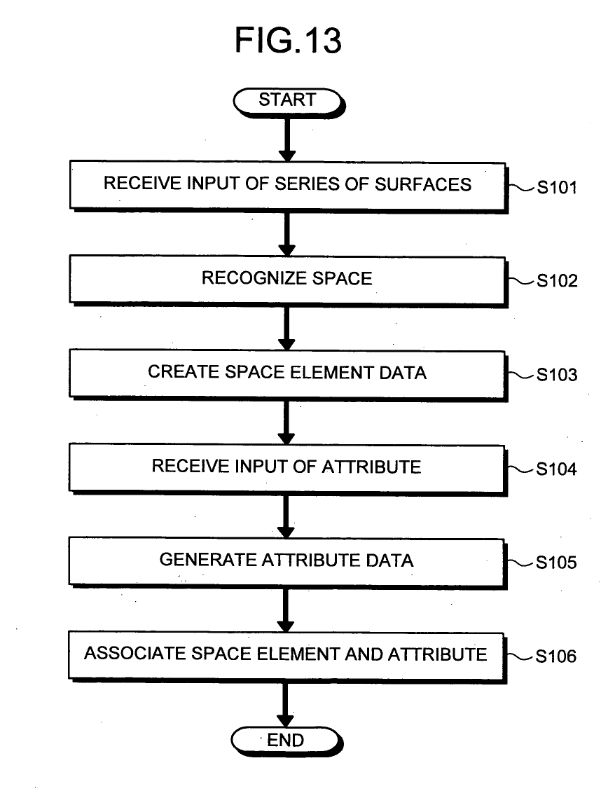

FIG. 13 is a flowchart of a processing procedure of the three-dimensional CAD apparatus 100 shown in FIG. 2. This figure shows a procedure for creating space element data of the series-of-surfaces definition type and adding an attribute to the space element data.

As shown in FIG. 13, when the input receiving unit 132a of the space-element processing unit 132 receives an input of a series of surfaces consisting of plural surfaces (step S101), the space-element recognizing unit 132b recognizes an area surrounded by those surfaces as a space (step S102). Then, the generating/updating unit 132c generates space element data representing the space and causes the space-element storing unit 142 to store the space element data (step S103).

When the input receiving unit 133a of the attribute processing unit 133 receives an input of attribute information (step S104), the generating/updating unit 133b generates attribute data based on the information and causes the attribute storing unit 143 to store the attribute data (step S105). Then, the association processing unit 134 adds an ID of this attribute information to the space element data stored at step S103 to complete a series of processing (step S106).

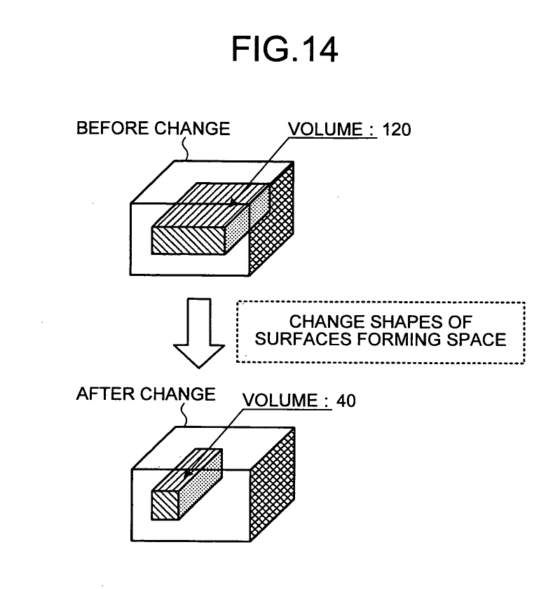

Subsequently, a processing procedure for various kinds of processing, which associates space element data and attribute data, is explained. Before explaining the processing procedure, an outline of the various kinds of processing is explained citing examples. FIG. 14 is a schematic for explaining an operation to be performed when a shape of a space element, to which an attribute of displaying a volume as a comment is added, is changed.

As shown in the figure, a comment indicating that a volume of the space is 120 milliliters is added to a space before change. This numeral 120 is not inputted by a designer, but is a result of calculation of the numerical-value calculating unit 132d of the space-element processing unit 132 acquired by the association processing unit 134 based on a content of definition of an attribute.

In this case, unlike the case of FIG. 20, a space is created as shape data and associated with attribute data of the comment. Thus, when a shape of the space is changed, the volume indicated by the comment is updated following the change. In other words, a designer is not required to correct the comment according to a change in a design, and a correct volume of the space is always indicated by the comment.

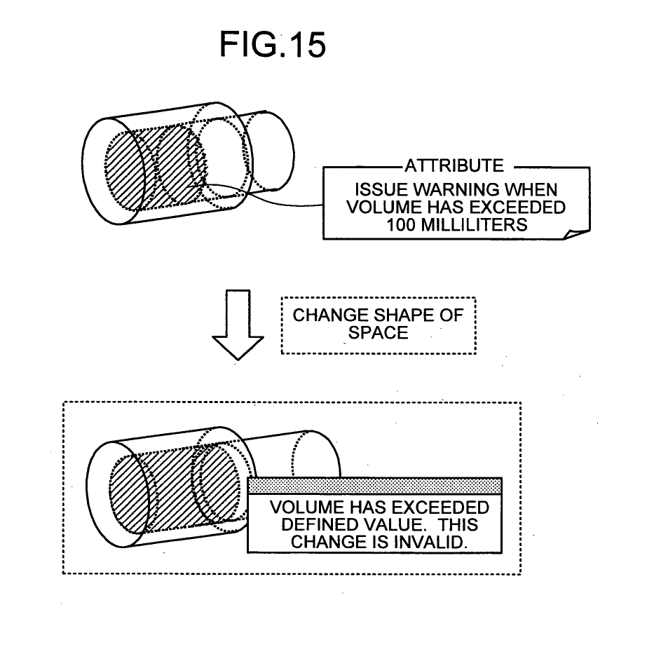

Another example is explained. FIG. 15 is a schematic for explaining an operation to be performed when an attribute of issuing a warning is set in a space element. As shown in the figure, attribute data, which indicates that a warning is displayed when a volume exceeds 100 milliliters, is added to a space element. In this case, it is checked whether a volume has exceeded a threshold value every time a shape of a space is changed, and when the volume has exceeded the threshold value, a warning is displayed. Note that, as the warning, not only screen display but also a warning sound, voice, or the like can be used.

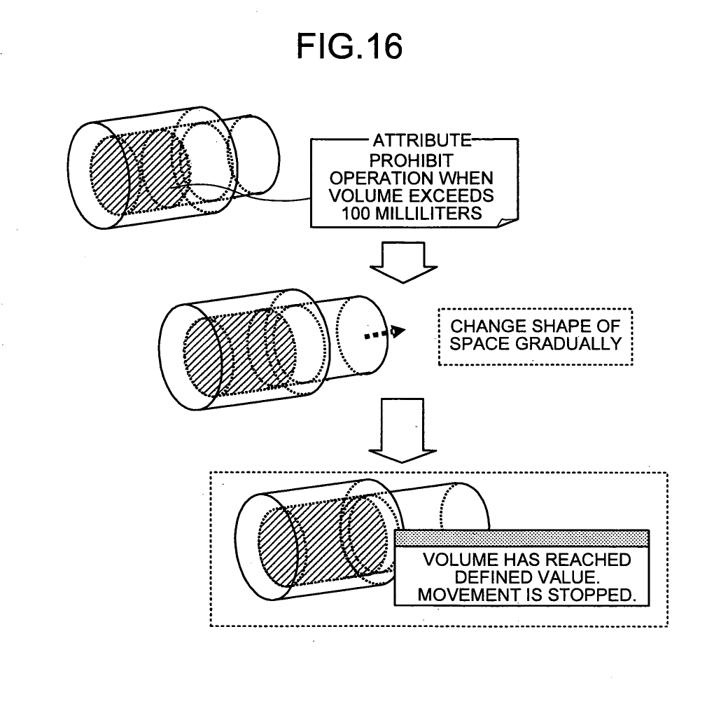

It is also possible to prohibit operation by a user instead of issuing a warning when a predetermined condition is met. FIG. 16 is a schematic for explaining an operation to be performed when an attribute of prohibiting operation by a user is set in a space element. As shown in the figure, attribute data, which indicates that operation is prohibited when a volume exceeds 100 milliliters, is added to a space element. In this case, it is checked whether a volume has reached a threshold value every time a shape of a space is changed, and when the volume has reached the threshold value, it is impossible to further increase the volume.

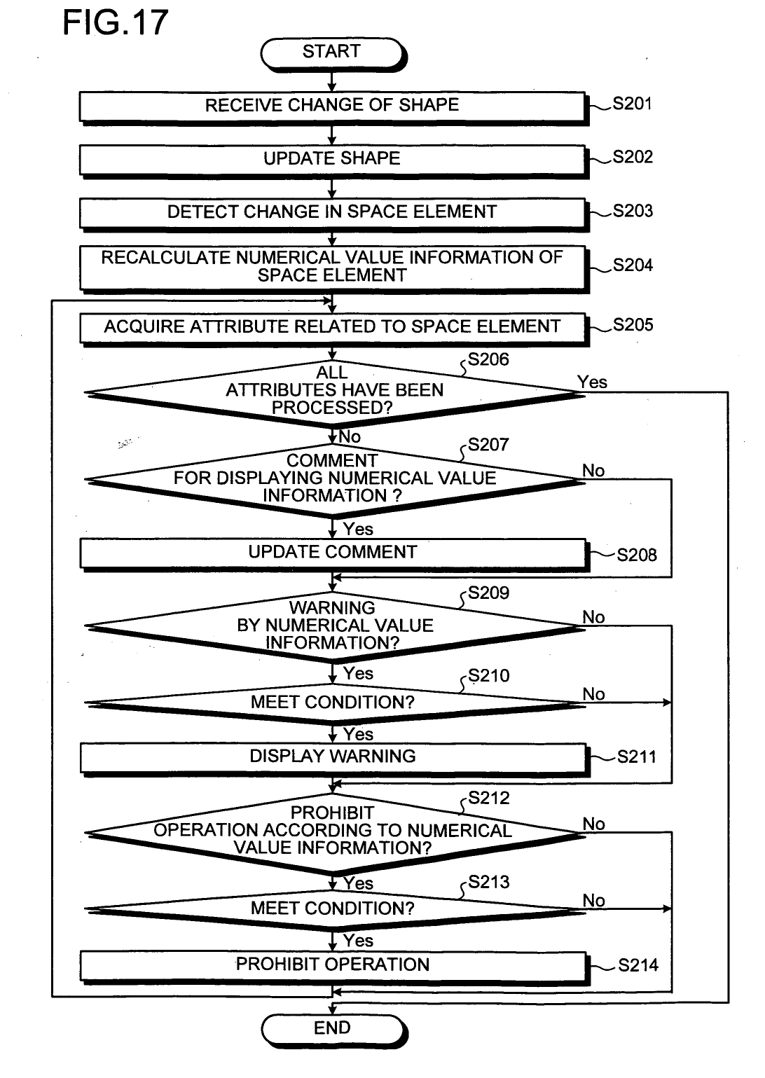

A processing procedure of the three-dimensional CAD apparatus 100 for realizing the operations described above is explained. FIG. 17 is a flowchart of a processing procedure to be taken when a shape of a space element is changed. As shown in the figure, when the input receiving unit 131a or the input receiving unit 132a receives an input of a change in a shape of a space element (step S201), the shape recognizing unit 131b or the space-element recognizing unit 132b recognizes a shape after the change. Then, the generating/updating unit 131c or the generating/updating unit 132c updates shape data according to the shape after the change (step S202).

When the shape of the space element is changed, the space-element processing unit 132 detects the change (step S203), causes the numerical-value calculating unit 132d to recalculate various numerical values such as a volume (step S204), and notifies the association processing unit 134 that the space element is changed. The association processing unit 134, which receives the notification, acquires one of unprocessed attribute data added to the space element (step S205). When there is no attribute data added to the space element or when all attribute data have been processed (“Yes” at step S206), the processing is completed.

When the association processing unit 134 acquires unprocessed data (“No” at step S206), the association processing unit 134 determines whether an attribute of the attribute data is a comment for displaying numerical value information. When the attribute is the comment (“Yes” at step S207), the association processing unit 134 acquires necessary numerical value data from the numerical-value calculating unit 132d and updates a content of the comment (step S208).

Subsequently, the association processing unit 134 confirms whether the acquired attribute is an attribute of issuing a warning when a predetermined condition is met. When the acquired attribute is the attribute of issuing a warning (“Yes” at step S209), the association processing unit 134 acquires necessary numerical value data from the numerical-value calculating unit 132d and causes the determining unit 133c to determine whether the numerical value data meets a condition. When it is determined that the numerical value data meets the condition (“Yes” at step S210), the association processing unit 134 issues a warning (step S211).

Subsequently, the association processing unit 134 confirms whether the acquired attribute is an attribute of prohibiting operation by a user when a predetermined condition is met. When the acquired attribute is the attribute of prohibiting operation by a user (“Yes” at step S212), the association processing unit 134 acquires necessary numerical value data from the numerical-value calculating unit 132d and causes the determining unit 133c to determine whether the numerical value data meets a condition. When it is determined that the numerical value data meets the condition (“Yes” at step S213), the association processing unit 134 prohibits operation by a user (step S214).

When the processing described above is completed, the association processing unit 134 returns to the step S205 and acquires the next unprocessed attribute data. In this way, the association processing unit 134 executes the steps S205 to S214 repeatedly until all the attribute data are processed.

Note that the association operation for the space element data and the attribute data shown in FIGS. 14 to 16 is only an example. The three-dimensional CAD apparatus according to the embodiment is capable of performing other association operations.

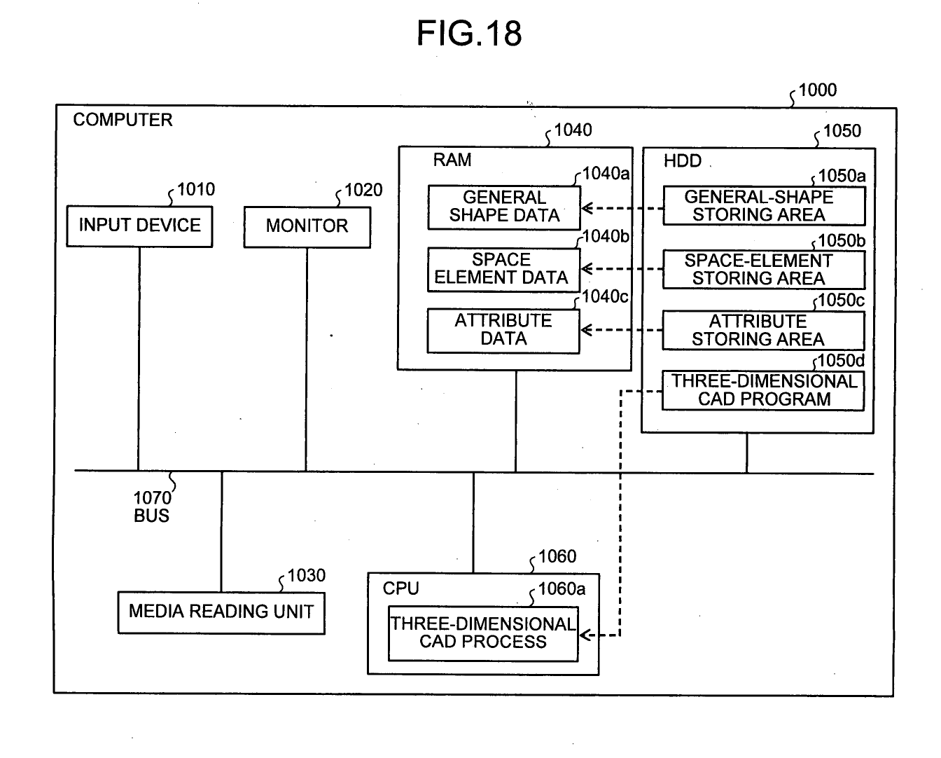

It is possible to realize the various kinds of processing explained in the embodiment by causing a computer to execute a program prepared in advance. Thus, an example of a computer, which executes a program for realizing the three-dimensional CAD apparatus according to this embodiment, is explained below with reference to FIG. 18.

FIG. 18 is a functional block diagram of a computer 100 that executes a three-dimensional CAD program. The computer 1000 includes an input device 1010 that receives an input of data from a user, a monitor 1020, a media reading device 1030 that reads a program from recording media having various programs recorded therein, a Random Access Memory (RAM) 1040 that temporarily stores various kinds of information, a Hard Disk Drive (HDD) 1050, and a CPU 1060, which are connected via a bus 1070.

The HDD 1050 stores a three-dimensional CAD program 1050d that is a program showing a function same as the function of the three-dimensional CAD apparatus 100. The CPU 1060 reads out the three-dimensional CAD program 1050d from the HDD 1050 and executes the three-dimensional CAD program 1050d, whereby the program functions as a three-dimensional CAD process 1060a. The three-dimensional CAD process 1060a corresponds to the control unit 130 shown in FIG. 2.

The CPU 1060 reads out necessary information from a general-shape storing area 1050a, a space-element storing area 1050b, and an attribute storing area 1050c of the HDD 1050 and stores the information in the RAM 1040 as general shape data 1040a, space element data 1040b, and attribute data 1040c. The CPU 1060 executes various kinds of data processing based on the general shape data 1040a, the space element data 1040b, and the attribute data 1040c stored in the RAM 1040. The general-shape storing area 1050a, the space-element storing area 1050b, and the attribute storing area 1050c correspond to the general-shape storing unit 141, the space-element storing unit 142, and the attribute storing unit 143 shown in FIG. 2, respectively.

Note that the three-dimensional CAD program 1050d does not always has to be stored in the HDD 1050. The computer 1000 may read out and execute a three-dimensional CAD program stored in a storage medium like a CD-ROM. It is also possible that three-dimensional CAD programs are stored in other computers (or servers) connected to the computer 1000 via a public line, the Internet, a LAN, a WAN, or the like and the computer 1000 reads out the programs from the computers (or the servers).

As described above, in the embodiment, the space-element processing unit 132 recognizes a shape of a space according to the various systems and keeps the shape as space element data. Thus, it is possible to treat spaces of various shapes as shape information. In addition, in the embodiment, the association processing unit 134 performs various kinds of processing according to attribute data associated with the space element data. Thus, it is possible to support a designer's work using the space element data effectively.

According to the invention, at the association processing step, various kinds of processing are performed according to attribute data associated with space element data. Thus, it is possible to support a designer's work using the space element data effectively.

Moreover, at the association processing step, a surface area or a volume of a space is displayed according to attribute data associated with space element data. Thus, an accurate surface area or volume is always displayed without requiring a designer to describe a surface area or a volume.

Furthermore, at the association processing step, when predetermined conditions are met, a warning is issued according to attribute data associated with space element data. Thus, it is possible to prevent a designer from performing wrong designing against a design intention.

Moreover, at the association processing step, when predetermined conditions are met, operation by a user is prohibited according to attribute data associated with space element data. Thus, it is possible to prevent a designer from performing wrong designing against a design intension.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recoding medium that stores a computer program for supporting designing work for three-dimensional shapes, causing a computer to execute:
recognizing a shape of a space based on information inputted to the three-dimensional CAD apparatus;
generating space element data that represents the shape of the space;
generating a attribute data based on the information;
associating the attribute data with the space element data; and
performing processing defined by the attribute data according to the space element data.

2. The computer-readable recoding medium according to claim 1, wherein, when the attribute data associated with space element data includes an instruction to display information of a space represented by the space element data in a predetermined position, the performing includes displaying the information of the space according to the instruction, wherein the information of the space corresponds to one of a surface area and a volume of the space.

3. The computer-readable recoding medium according to claim 1, wherein, when the attribute data associated with the space element data includes an instruction to issue a warning when information of a space represented by the space element data meets a predetermined condition, the performing includes issuing the warning according to the instruction, wherein the information of the space corresponds to one of a surface area and a volume of the space.

4. The computer-readable recoding medium according to claim 1, wherein, when the attribute data associated with the space element data includes an instruction to prohibit operation by a user when information of a space represented by the space element data meets a predetermined condition, the performing includes prohibiting the operation according to the instruction.

5. The computer-readable recoding medium according to claim 1, further comprising causing a user to designate a point, wherein
when a point is designated, the recognizing includes recognizing a closed space including the point as the shape of the space.

6. The computer-readable recoding medium according to claim 1, further comprising causing a user to designate a series of surfaces, wherein
when the series of surfaces are designated, the recognizing includes recognizing a closed space surrounded and formed by the series of surfaces as the shape of the space.

7. The computer-readable recoding medium according to claim 1, further comprising causing a user to designate a series of points, wherein
when the series of points are designated, the recognizing includes recognizing a closed space formed by a predetermined shape passing the series of points as the shape of the space.

8. The computer-readable recoding medium according to claim 1, further comprising causing a user to designate a point, wherein
when the point is designated, the recognizing includes recognizing a predetermined shape around the point as the shape of the space.

9. The computer-readable recoding medium according to claim 1, further comprising causing a user to designate at least one of a solid, a surface, a first line, a second line, wherein
when the solid and the first line are designated, the recognizing includes recognizing a first closed space formed by a locus of the solid moving along the first line as the shape of the space, and
when the surface and the second line is designated, the recognizing includes recognizing a second closed space formed by a locus of the solid moving along the second line as the shape of the space.

10. A three-dimensional CAD apparatus that supports designing work for three-dimensional shapes, comprising:
a space-element processing unit that recognizes a shape of a space based on information inputted to the three-dimensional CAD apparatus, and generates space element data that represents the shape of the space;
an attribute processing unit that generates an attribute data based on the information; and
an association processing unit that associates the attribute data with the space element data, and performs processing defined by the attribute data according to the space element data.

11. A method for supporting designing work for three-dimensional shapes, comprising:
recognizing a shape of a space based on information inputted to the three-dimensional CAD apparatus;
generating space element data that represents the shape of the space;
generating a attribute data based on the information;
associating the attribute data with the space element data; and
performing processing defined by the attribute data according to the space element data.
